(19) United States
(12) Patent Application Publication
(10) Pub. No.: US 2024/0322224 A1
(43) Pub. Date: Sep. 26, 2024

(54) TITANIC ACID-BASED SOLID ELECTROLYTE MATERIAL

(71) Applicant: OTSUKA CHEMICAL CO., LTD., Osaka-city, Osaka (JP)

(72) Inventors: Mizuki Ito, Tokushima-city (JP); Hiroyoshi Mori, Tokushima-city (JP)

(73) Assignee: OTSUKA CHEMICAL CO., LTD., Osaka-city, Osaka (JP)

(21) Appl. No.: 18/578,141

(22) PCT Filed: Jun. 28, 2022
(86) PCT No.: PCT/JP2022/025663

§ 371 Date: Jan. 10, 2024

(30) Foreign Application Priority Data
Jul. 13, 2021 (JP) 2021-115469

(51) Int. Cl. H01M 10/0562; H01M 10/0525

(52) U.S. Cl. CPC H01M 10/0562; H01M 10/0525; H01M 2300/0071; H01M 2300/0094

(57) ABSTRACT

Provided is a titanic acid-based solid electrolyte material free from risk of production of hydrogen sulfide, free of rare earth, and having good electrochemical stability and lithium-ion conductivity. A titanic acid-based solid electrolyte material 1 is made of a titanate having a structure in which a plurality of host layers 2 are laid one on top of another, the host layer 2 being formed so that octahedra each formed of a titanium atom coordinated with six oxygen atoms are two-dimensionally chained while sharing ridges, and lithium ions 3 and divalent or higher-valent cations (α) 4 are intercalated in interlayers between the host layers 2, titanium sites in the host layers 2 being partially substituted by monovalent to trivalent cations (β).

### TECHNICAL FIELD

The present invention relates to titanic acid-based solid electrolyte materials.

### BACKGROUND ART

Lithium-ion secondary batteries are secondary batteries that are composed of a positive electrode, a negative electrode, a separation film preventing physical contact between the positive electrode and the negative electrode, and an electrolyte and perform charging and discharging by migration of lithium ions through the electrolyte between the positive electrode and the negative electrode. The lithium-ion secondary batteries are used as power sources for notebook personal computers, tablet terminals, and smartphones because they have excellent energy density and power density and are effective in size reduction and weight reduction. These batteries are also attracting attention as power sources for electric vehicles.

A conventional electrolyte used in such batteries is an electrolytic solution containing a flammable organic solvent. Therefore, liquid leakage is likely to occur and excessive charging or discharging may cause short circuit inside the batteries and thus cause ignition of the batteries. In view of this, in order to improve safety, all-solid-state lithium-ion secondary batteries have recently been researched and developed in which an inorganic solid electrolyte material is used instead of an electrolytic solution.

Inorganic solid electrolyte materials for use in all-solid-state lithium-ion secondary batteries are classified, based on whether the principal element forming the skeleton is an oxygen atom or a sulfur atom, into two types: sulfide-based solid electrolyte materials and oxide-based solid electrolyte materials. Sulfide-based solid electrolyte materials show high lithium-ion conductivity compared to oxide-based solid electrolyte materials, but have high reactivity with moisture and therefore have safety problems, such as production of hydrogen sulfide. For this reason, consideration has been made of methods for improving the lithium-ion conductivity of oxide-based solid electrolyte materials, such as (La, Li)TiO₃ (hereinafter, referred to as “LLTO”), Li₆La₂CaTa₂O₁₂, Li₆La₂ANb₂O₁₂ (A=Ca or Sr), and Li₂Nd₃TeSbO₁₂. For example, a method of doping LLTO with 1% to 5% by mass sulfur is disclosed (see Patent Literature 1).

### CITATION LIST

### Patent Literature

Patent Literature 1: JP-A-2018-73805

### SUMMARY OF INVENTION

### Technical Problem

However, since the oxide-based solid electrolyte material in Patent Literature 1 contains sulfur, it may produce hydrogen sulfide. In addition, since rare earth is used in the material, this causes concern about production cost. Furthermore, high requirements have recently been imposed on lithium-ion secondary batteries including a solid electrolyte, but conventional oxide-based solid electrolyte materials have a problem of the electrochemical stability being still insufficient.

An object of the present invention is to provide a titanic acid-based solid electrolyte material free from risk of production of hydrogen sulfide, free of rare earth, and having good electrochemical stability and lithium-ion conductivity, a method for producing the titanic acid-based solid electrolyte material, and a solid electrolyte and a lithium-ion secondary battery in each of which the titanic acid-based solid electrolyte material is used.

### Solution to Problem

The present invention provides the following titanic acid-based solid electrolyte material, method for producing the titanic acid-based solid electrolyte material, and the following solid electrolyte and lithium-ion secondary battery in each of which the titanic acid-based solid electrolyte material is used.

Aspect 1: A titanic acid-based solid electrolyte material made of a titanate having a structure in which a plurality of host layers are laid one on top of another, the host layer being formed so that octahedra each formed of a titanium atom coordinated with six oxygen atoms are two-dimensionally chained while sharing ridges, and lithium ions and divalent or higher-valent cations (α) are intercalated in interlayers between the host layers, titanium sites in the host layers being partially substituted by monovalent to trivalent cations (β).

Aspect 2: The titanic acid-based solid electrolyte material according to aspect 1, wherein the cations (α) are divalent to octavalent cations.

Aspect 3: The titanic acid-based solid electrolyte material according to aspect 1 or 2, wherein the cations (α) comprise at least one type of ion selected from the group consisting of a magnesium ion, an aluminum ion, a calcium ion, a zinc ion, a strontium ion, a barium ion, [Al₁₃O₄(OH)₂₄(H₂O)₁₂]⁷⁺, [Ga₁₃O₄(OH)₂₄(H₂O)₁₂]⁷⁺, and [Zr₄(OH)₈(H₂O)₁₆]⁸⁺.

Aspect 4: The titanic acid-based solid electrolyte material according to any one of aspects 1 to 3, wherein the cations (α) have an ionic radius of 0.50 Angstroms or more.

Aspect 5: The titanic acid-based solid electrolyte material according to any one of aspects 1 to 4, wherein a content of the lithium ions present in the interlayers between the host layers is 35% by mole to 95% by mole relative to 100% by mole of ions present in the interlayers between the host layers.

Aspect 6: The titanic acid-based solid electrolyte material according to any one of aspects 1 to 5, wherein a content ratio between the cations (α) and the lithium ions present in the interlayers between the host layers ((cations (α))/(lithium ions)) is 1/99 to 60/40 in terms of molar ratio.

Aspect 7: The titanic acid-based solid electrolyte material according to any one of aspects 1 to 6, wherein the cations (β) comprise at least one type of ion selected from the group consisting of a hydrogen ion, an oxonium ion, a lithium ion, and a magnesium ion.

Aspect 8: The titanic acid-based solid electrolyte material according to any one of aspects 1 to 7, wherein more than 0% by mole and not more than 40% by mole of the titanium sites in the host layers are substituted by the cations (β).

Aspect 9: The titanic acid-based solid electrolyte material according to any one of aspects 1 to 8, wherein an interlayer distance between the host layers is 5 Angstroms to 20 Angstroms.

Aspect 10: A method for producing the titanic acid-based solid electrolyte material according to any one of aspects 1 to 9, the method including the steps of: (I) allowing a titanic acid having a layered crystal structure to interact with a basic compound or a salt of the basic compound; (II) mixing a compound obtained in the step (I) and a salt of the cations (α); and (III) mixing a compound obtained in the step (II) and a lithium salt.

Aspect 11: A method for producing the titanic acid-based solid electrolyte material according to any one of aspects 1 to 9, the method including the step (IV) of mixing a titanic acid having a layered crystal structure, a lithium salt, and a salt of the cations (α).

Aspect 12: A solid electrolyte containing the titanic acid-based solid electrolyte material according to any one of aspects 1 to 9.

Aspect 13: A lithium-ion secondary battery including the solid electrolyte according to aspect 12.

### Advantageous Effects of Invention

The present invention enables provision of a titanic acid-based solid electrolyte material free from risk of production of hydrogen sulfide, free of rare earth, and having good electrochemical stability and lithium-ion conductivity.

With the use of a solid electrolyte containing the above titanic acid-based solid electrolyte material, a high-power lithium-ion secondary battery having excellent safety can be obtained.

### BRIEF DESCRIPTION OF DRAWINGS

FIG. 1 is a schematic view showing a titanic acid-based solid electrolyte material according to one embodiment of the present invention.

FIG. 2 is a schematic cross-sectional view showing a lithium-ion secondary battery according to one embodiment of the present invention.

FIG. 3 is Nyquist diagrams of samples obtained in Examples 1 to 4 and Comparative Examples 1 to 2.

FIG. 4 is Nyquist diagrams of samples obtained in Examples 1 to 4 and Comparative Example 1.

FIG. 5 is dQ/dV curves of the sample obtained in Example 1.

FIG. 6 is dQ/dV curves of the sample obtained in Example 2.

FIG. 7 is dQ/dV curves of the sample obtained in Example 3.

FIG. 8 is dQ/dV curves of the sample obtained in Example 4.

FIG. 9 is dQ/dV curves of the sample obtained in Comparative Example 1.

FIG. 10 is charge-discharge curves of an all-solid-state battery in which the sample obtained in Example 1 was used.

### DESCRIPTION OF EMBODIMENTS

Hereinafter, a description will be given of an example of a preferred embodiment for working of the present invention. However, the following embodiment is simply illustrative. The present invention is not at all limited by the following embodiment.

### <Titanic Acid-Based Solid Electrolyte Material>

A titanic acid-based solid electrolyte material according to the present invention is made of a lepidocrocite titanate having a structure in which a plurality of host layers are laid one on top of another, the host layer being formed so that octahedra each formed of a titanium atom coordinated with six oxygen atoms are two-dimensionally chained while sharing ridges, and lithium ions and divalent or higher-valent cations (α) are intercalated in the interlayers between the host layers, titanium sites in the host layers being partially substituted by monovalent to trivalent cations (β). The lepidocrocite titanate may or may not contain crystallization water in the interlayers between the host layers and/or other sites.

The host layer is formed so that octahedra each formed of a titanium atom coordinated with six oxygen atoms are two-dimensionally chained while sharing ridges, and forms a single layer serving as a unit of the layered structure (laminate). The individual host layer is originally electrically neutral, but is negatively charged since its tetravalent titanium sites are partially substituted by monovalent to trivalent cations (β) or are partially vacant. The negative charges of the host layer are compensated for by positive charges of lithium ions, cations (α) or so on present between the host layer and each of the other host layers (hereinafter, referred to as “in the interlayers”), which ensures the electrical neutrality of this compound.

More specifically, FIG. 1 is a schematic view showing a titanic acid-based solid electrolyte material according to an embodiment of the present invention. As shown in FIG. 1, the titanic acid-based solid electrolyte material 1 has a crystal structure in which a plurality of host layers 2 are laid one on top of another and lithium ions 3 and cations (α) 4 are intercalated in the interlayers between the host layers 2. Furthermore, the individual host layer 2 is formed so that octahedra each formed of a titanium atom coordinated with six oxygen atoms are two-dimensionally chained while sharing ridges. FIG. 1 is a schematic view shown as an example and the titanic acid-based solid electrolyte material according to the present invention is not limited to the structure in the schematic view of FIG. 1.

In relation to the host layer, from the viewpoint of further increasing the lithium-ion conductivity, more than 0% by mole and not more than 40% by mole of the titanium sites in the host layer are preferably substituted by cations (β), not less than 5% by mole and not more than 30% by mole of the titanium sites are more preferably substituted by cations (β), and not less than 10% by mole and not more than 20% by mole of the titanium sites are still more preferably substituted by cations (β).

Examples of the cation (β) include a hydrogen ion, an oxonium ion, an alkali metal ion, an alkaline earth metal ion, a zinc ion, a nickel ion, a copper ion, an iron ion, an aluminum ion, a gallium ion, and a manganese ion. From the viewpoint of further increasing the lithium-ion conductivity, the cations (0) preferably comprise at least one type of ion selected from the group consisting of a hydrogen ion, an oxonium ion, a lithium ion, and a magnesium ion.

The titanium sites in the host layer may be partially vacant. When the titanium sites have vacancies, more than 0% by mole and not more than 20% by mole of the titanium sites in the host layer are preferably vacant from the viewpoint of further increasing the lithium-ion conductivity.

The titanate making up the titanic acid-based solid electrolyte material has a layered structure in its crystal structure and the interlayers form two-dimensional conduction paths for lithium ions, which provides the lithium-ion conductivity. It can be thought that the cations (α) intercalated in the interlayers expand the interlayers serving as the conduction paths to provide an excellent lithium-ion conductivity and the host layers and the cations (α) form pillars through strong electrostatic interaction therebetween to suppress changes in interlayer distance, thus increasing the electrochemical stability.

Therefore, the titanic acid-based solid electrolyte material according to the present invention can increase both the electrochemical stability and the lithium-ion conductivity.

The cations (α) are divalent or higher-valent cations and preferably divalent to octavalent cations. Specific examples of the cation (a) include: monoatomic cations, such as a magnesium ion, an aluminum ion, a calcium ion, a zinc ion, a strontium ion, and a barium ion; and polynuclear metal cations, such as polycations having a Keggin structure (including [Al₁₃O₄(OH)₂₄(H₂O)₁₂]⁷⁺, [Al₃₀O₈(OH)₅₆(H₂O)₂₄]¹⁸⁺, and [Ga₁₃O₄(OH)₂₄(H₂O)₁₂]⁷⁺), and [Zr₄(OH)₈(H₂O)₁₆]³⁺, the preferred cation is a magnesium ion, a calcium ion, a barium ion, [Al₁₃O₄(OH)₂₄(H₂O)₁₂]⁷⁺, [Ga₁₃O₄(OH)₂₄(H₂O)₁₂]⁷⁺ or [Zr₄(OH)₈(H₂O)₁₆]⁸⁺, and the more preferred cation is an aluminum ion, a barium ion or [Al₁₃O₄(OH)₂₄ (H₂O)₁₂]⁷⁺. These cations (α) may be used singly or in combination of two or more of them. From the viewpoint of further increasing the thermal stability, the cations (α) are preferably monoatomic cations.

The ionic radius of the cations (α) is, from the viewpoint of further increasing the electrochemical stability, preferably 0.50 Angstroms or more, more preferably 0.80 Angstroms or more, still more preferably 1.0 Angstroms or more, and particularly preferably 1.2 Angstroms or more. Furthermore, the ionic radius of the cations (α) is, from the viewpoint of further increasing the lithium-ion conductivity, preferably 10.0 Angstroms or less, more preferably 5.0 Angstroms or less, and still more preferably 2.0 Angstroms or less.

The “ionic radius” used herein can be represented by the Pauling's ionic radius as for monoatomic cations. For example, the ionic radius of the aluminum ion is 0.50 Angstroms, the ionic radius of the lithium ion is 0.60 Angstroms, the ionic radius of the magnesium ion is 0.65 Angstroms, the ionic radius of the zinc ion is 0.74 Angstroms, the ionic radius of the calcium ion is 0.99 Angstroms, the ionic radius of the strontium ion is 1.13 Angstroms, and the ionic radius of the barium ion is 1.35 Angstroms. On the other hand, as for polynuclear metal cations, their ionic radius is represented by the half of the interatomic distance determined from a structure obtained by monocrystal structure analysis or determined by the X-ray small angle scattering method (SAXS) or the extended X-ray absorption fine structure (EXAFS). For example, the ionic radius of [Al₁₃O₄(OH)₂₄(H₂O)₁₂]⁷⁺ is 4.5 Angstroms and the ionic radius of [Zr₄(OH)₈(H₂O)₁₆]⁸⁺ is 2.0 Angstroms.

Particularly, when the cations (α) are monoatomic cations, the ionic radius of the cations (α) is, from the viewpoint of further increasing the electrochemical stability, preferably 0.50 Angstroms or more, more preferably 0.80 Angstroms or more, still more preferably 1.0 Angstroms or more, and particularly preferably 1.2 Angstroms or more. Furthermore, when the cations (α) are monoatomic cations, the ionic radius of the cations (α) is, from the viewpoint of further increasing the lithium-ion conductivity, preferably 2.5 Angstroms or less, more preferably 2.3 Angstroms or less, and still more preferably 2.0 Angstroms or less.

On the other hand, when the cations (α) are polynuclear metal cations, the ionic radius of the cations (α) is preferably 2.0 Angstroms or more, more preferably 3.0 Angstroms or more, preferably an 10.0 Angstroms or less, and more preferably 5.0 Angstroms or less. In this case, the lithium-ion conductivity and the electrochemical stability can be further increased.

The interlayer distance between the host layers of the titanate making up the titanic acid-based solid electrolyte material is preferably 5 Angstroms to 20 Angstroms and more preferably 8.5 Angstroms to 16 Angstroms. The above titanate has a layered structure in its crystal structure and its interlayers form two-dimensional conduction paths for lithium ions, which provides the lithium-ion conductivity. It can be thought that by defining the interlayer distance within the above range, the activation energy for ion conduction becomes even smaller and thus the lithium-ion conductivity is made even better.

In an X-ray diffraction pattern of the material, several peaks appearing at equal intervals in a low angle range (approximately 2θ=20° or less) are derived from the layered structure of titanic acid. The interlayer distance can be calculated from the diffraction angle (2θ) of the primary peak appearing at the lowest angle. Specifically, the interlayer distance can be calculated using the Bragg's equation “d=nλ/2 sin θ” (where d is the interlayer distance (Angstrom), θ is a value obtained by dividing the diffraction angle (2θ) of the primary peak by 2, λ is a wavelength of the CuKα rays of 1.5418 Angstroms, and n is a positive integer (n=1 for the primary peak)).

Lithium ions and cations (α) only may be intercalated in the interlayers between the host layers. Alternatively, without impairing preferred physical properties of the present invention, hydrogen ions, oxonium ions or alkali metal ions, such as potassium ions or sodium ions, may be intercalated.

The content of lithium ions present in the interlayers between the host layers is, from the viewpoint of further increasing the lithium-ion conductivity, preferably 35% by mole to 95% by mole and more preferably 50% by mole to 95% by mole, relative to 100% by mole of ions present in the interlayers between the host layers. The content of cations (α) present in the interlayers between the host layers is, from the viewpoint of further increasing the electrochemical stability, preferably 0.5% by mole to 50% by mole and more preferably 2.0% by mole to 30% by mole, relative to 100% by mole of ions present in the interlayers between the host layers. The content ratio between cations (α) and lithium ions present in the interlayers between the host layers ((cations (α))/(lithium ions)) is, from the viewpoint of further increasing the lithium-ion conductivity and the electrochemical stability, preferably 1/99 to 60/40 and more preferably 3/97 to 30/70 in terms of molar ratio.

The titanate making up the titanic acid-based solid electrolyte material is formed of powdered particles, including spherical particles (inclusive of particles of a spherical shape with some asperities on its surface and particles of an approximately spherical shape, such as those having an elliptic cross-section), bar-like particles (inclusive of particles of an approximately bar-like shape as a whole, such as rodlike, columnar, prismoidal, reed-shaped, approximately columnar, and approximately reed-shaped particles), platy particles, blocky particles, particles of a shape with multiple projections (such as amoeboid, boomerang-like, cross, or kompeito-like shape), and particles of an irregular shape. The size of the particles is not particularly limited, but the average particle diameter is preferably 0.01 μm to 20 μm, more preferably 0.05 μm to 10 μm, and still more preferably 0.1 μm to 5 μm.

The “average particle diameter” herein refers to a particle diameter at a volume-based cumulative integrated value of 50% in a particle size distribution determined by the laser diffraction and scattering method (a volume-based 50% cumulative particle diameter), i.e., D₅₀ (a median diameter). This volume-based 50% cumulative particle diameter (D₅₀) is a particle diameter at a cumulative value of 50% in a cumulative curve of a particle size distribution determined on a volume basis, the cumulative curve assuming the total volume of particles to be 100%, where during accumulation the number of particles is counted from a smaller size side. These various types of particle shapes and particle sizes can be arbitrarily controlled depending on the shape of a titanate as a source material to be described hereinafter.

The titanate making up the titanic acid-based solid electrolyte material thus far described is preferably at least one compound selected from the group consisting of Li_{0.14}K_{0.05}Al_{0.12}Ti_{1.73}O_{3.7}·1.0H₂O, Li_{0.13}K_{0.04}Mg_{0.16}Ti_{1.73}O_{3.7}—1.7H₂O, and Li_{0.39}K_{0.09}Ba_{0.20}T_{1.73}O_{3.9}·1.0H₂O.

Since the titanic acid-based solid electrolyte material according to the present invention has excellent electrochemical stability and lithium-ion conductivity and is free of sulfur, it can be suitably used as a solid electrolyte material for a lithium-ion secondary battery. In addition, the titanic-acid solid electrolyte material according to the present invention is free from risk of production of hydrogen sulfide since it is free of sulfur, and it is excellent in production cost because of no use of rare earth.

### (Method for Producing Titanic Acid-Based Solid Electrolyte Material)

The method for producing the titanic acid-based solid electrolyte material according to the present invention is not limited to any particular production method so long as the above-described composition can be obtained, and an example is a production method of allowing a combination of a basic compound or its salt, a salt of the cations (α) and a lithium salt or a combination of a lithium salt and a salt of the cations (α) to interact with a titanic acid having a layered crystal structure (hereinafter, referred to as a layered titanic acid). Specifically, examples include a first production method of allowing a basic compound or its salt, a salt of the cations (α)), and a lithium salt to interact with a layered titanic acid and a second production method of allowing a lithium salt and a salt of the cations (α) to interact with a layered titanic acid.

The layered titanic acid is obtained by mixing a lepidocrocite titanate having a layered crystal structure (hereinafter, referred to as a source titanate) with an acid (acid treatment) and substituting exchangeable metal cations with hydrogen ions or hydronium ions.

The acid treatment is preferably conducted under a wet condition. By this acid treatment, cations, such as metal ions by which some of the titanium sites in the host layers have been substituted and metal ions between the host layers, are substituted by hydrogen ions or hydronium ions as the layered structure of the source titanate remains maintained, and, as a result, a layered titanic acid can be produced. The term titanic acid used here includes a hydrated titanic acid in which water molecules are present in the interlayers.

The acid for use in the acid treatment is not particularly limited and may be a mineral acid, such as hydrochloric acid, sulfuric acid, nitric acid, phosphoric acid or boric acid, or an organic acid. The acid treatment can be performed, for example, by mixing an acid into an aqueous slurry of a source titanate, the reaction temperature is preferably 5° C. to 80° C., and the reaction time is preferably an hour to three hours.

The exchange rate of cations can be controlled by appropriately adjusting the type and concentration of the acid and the concentration of the source titanate slurry according to the type of the source titanate. Furthermore, the exchange rate of cations is preferably 70% to 100% relative to the volume of exchangeable cations in the source titanate from the viewpoint of the interlayer distance of the resultant lepidocrocite titanate. The term “volume of exchangeable cations” refers to, for example, a value represented by x+my when a source titanate is represented by the general formula AₓM_{y}Ti_{(2-y)}C₄ [where A is at least one of alkali metals except for Li, M is at least one selected from among Li, Mg, Zn, Ga, Ni, Cu, Fe, Al, and Mn, x is a number from 0.5 to 1.0, and y is a number from 0.25 to 1.0] and m represents the valence of M.

Examples of the source titanate include AₓM_{y}Ti_{(2-y)}C₄ [where A is at least one of alkali metals except for Li, M is at least one selected from among Li, Mg, Zn, Ga, Ni, Cu, Fe, Al, and Mn, x is a number from 0.5 to 1.0, and y is a number from 0.25 to 1.0], A_{0.2-0.8}Li_{0.2-0.4}Ti_{1.6-1.8}O_{3.7-3.95} [where A is at least one of alkali metals except for Li], A_{0.2-0.8}Mg_{0.3-0.5}Ti_{1.5-1.7}O_{3.7-3.95} [where A is at least one of alkali metals except for Li], and A_{0.5-0.7}Li_{(0.27-x)}M_{y}Ti_{(1.73-z)}O_{3.85-3.95} [where: A is at least one of alkali metals except for Li; M is at least one selected from among Mg, Zn, Ga, Ni, Cu, Fe, Al, and Mn (except for combinations of different types of ions having different valences in using two or more types of ions); x=2y/3 and z=y/3 when M is a divalent metal; x=y/3 and z=2y/3 when M is a trivalent metal; and 0.004≤y≤0.4], and the preferred source titanate is at least one selected from the group consisting of A_{0.5-0.7}Li_{0.27}Ti_{1.73}O_{3.85-3.95} [where A is at least one of alkali metals except for Li] and A_{0.2-0.7}Mg_{0.40}Ti_{1.6}O_{3.7-3.95} [where A is at least one of alkali metals except for Li].

The first production method of allowing a basic compound or its salt, a salt of the cations (α) and a lithium salt to interact with a layered titanic acid includes: the step (I) of mixing a layered titanic acid with a basic compound or its salt; the step (II) of mixing a compound obtained in the step (I) with a salt of the cations (α); and the step (III) of mixing a compound obtained in the step (II) with a lithium salt.

When in the step (I) a layered titanic acid is mixed with a basic compound or its salt, the basic compound or its salt reacts by ion exchange with hydrogen ions, hydronium ions, and so on in the interlayers, thus expanding the interlayer distance.

The step (I) is preferably a wet treatment and is normally performed by adding a basic compound or its salt directly into a suspension containing a layered titanic acid dispersed into water or an aqueous medium or adding a dilution of the basic compound or its salt with water or an aqueous medium into the suspension, and stirring the mixture. The reaction temperature is preferably 25° C. to 85° C. and the reaction time is preferably an hour to three hours.

The basic compound or its salt is not particularly limited so long as it has an interlayer swelling effect of a layered titanic acid and is capable of control to a desired interlayer distance, and examples include primary to tertiary organic amines, organic ammonium salts, and organic phosphonium salts. Among them, primary to tertiary organic amines and quaternary organic ammonium salts are preferred.

Examples of the primary organic amines include methylamine, ethylamine, n-propylamine, n-butylamine, pentylamine, hexylamine, octylamine, dodecylamine, 2-ethylhexylamine, 3-methoxypropylamine, 3-ethoxypropylamine, octadecylamine, and their salts.

Examples of the secondary organic amines include diethylamine, dipentylamine, dioctylamine, dibenzylamine, di(2-ethylhexyl)amine, di(3-ethoxypropyl)amine, and their salts.

Examples of the tertiary organic amines include triethylamine, trioctylamine, tri(2-ethylhexyl)amine, tri(3-ethoxypropyl)amine, dipolyoxyethylenedodecylamine, dimethyldecylamine, and their salts.

Examples of the quaternary organic ammonium salts include dodecyltrimethylammonium salts, cetyltrimethylammonium salts, stearyltrimethylammonium salts, benzyltrimethylammonium salts, benzyltributylammonium salts, trimethylphenylammonium salts, dimethyldistearylammonium salts, dimethyldidecylammonium salts, dimethylstearylbenzylammonium salts, dodecyl bis(2-hydroxyethyl)methylammonium salts, trioctylmethylammonium salts, and dipolyoxyethylenedodecylmethylammonium salts.

Examples of the organic phosphonium salts include tetrabutylphosphonium salts, hexadecyltributylphosphonium salts, dodecyltributylphosphonium salts, and dodecyltriphenylphosphonium salts.

The amount of the basic compound or its salt added is, relative to the volume of exchangeable cations in the layered titanic acid, preferably 1.0 to 2.5 equivalents and more preferably 1.1 to 2.0 equivalents. If the amount of the basic compound or its salt added is smaller than the above lower limit, uniform expansion of the interlayer distance may not be expected. If the amount of the basic compound or its salt added is larger than the above upper limit, this may be economically inadvisable.

When in the step (II) a compound obtained in the step (I) is mixed with a salt of the cations (α), the salt of the cations (α) reacts by ion exchange with ions of the basic compound or so on in the interlayers and, thus, bulky cations (α) can be introduced into the interlayers while the interlayer distance expanded in the step (I) is maintained.

The step (II) is preferably a wet treatment and is normally performed by adding a salt of the cations (α) directly into a compound obtained in the step (I) or into a suspension containing the compound dispersed into water or an aqueous medium or adding a dilution of the salt of the cations (α) with water or an aqueous medium into the compound or the suspension, and stirring the mixture. The reaction temperature is preferably 25° C. to 85° C. and the reaction time is preferably 1 hour to 24 hours.

The salt of the cations (α) for use in the step (II) may be of any type that can introduce the cations (α) into the interlayers of the layered titanic acid and the preferred salts are aluminum chloride hexahydrate, magnesium chloride hexahydrate, and [Al₁₃O₄(OH)₂₄(H₂O)₁₂]⁷⁺.

The amount of the salt of the cations (α) mixed in the step (II) is, relative to the layered titanic acid obtained in the step (I), preferably 0.001 to 0.20 equivalents and more preferably 0.02 to 0.15 equivalents. If the amount of the salt of the cations (α) mixed in the step (II) is smaller than the above lower limit, the amount of the cations (α) introduced into the interlayers becomes small, which may not provide a sufficient electrostatic interaction with the host layers and may deteriorate the electrochemical stability. If the amount of the salt of the cations (α) mixed in the step (II) is larger than the above upper limit, the proportion of the cations (α) relative to the interlayer ions becomes large, which may deteriorate the lithium-ion conductivity.

When in the step (III) a compound obtained in the step (II) is mixed with a lithium salt, the lithium salt reacts by ion exchange with ions of the basic compound or so on in the interlayers.

The step (III) is preferably a wet treatment and is normally performed by adding a lithium salt directly into a suspension containing the compound obtained in the step (II) being dispersed into water or an aqueous medium or adding a dilution of the lithium salt with water or an aqueous medium into the suspension, and stirring the mixture. The reaction temperature is preferably 25° C. to 85° C. and the reaction time is preferably 1 hour to 12 hours. When, after the reaction, the mixture is dried to remove the solvent, such as water, a titanate making up a titanic acid-based solid electrolyte material according to the present invention can be produced.

The lithium salt for use in the step (III) may be of any type that can introduce lithium ions into the interlayers of the layered titanic acid, examples include lithium hydroxide monohydrate, lithium carbonate, lithium acetate, lithium citrate, lithium chloride, lithium nitrate, lithium sulfate, lithium phosphate, lithium bromide, lithium iodide, lithium tetraborate, LiPF₆, and LiBF₄, and the preferred lithium salt is lithium chloride.

The amount of the lithium salt mixed in the step (III) is, relative to the layered titanic acid obtained in the step (I), preferably 1.0 to 3.0 equivalents and more preferably 1.0 to 2.5 equivalents. If the amount of the lithium salt mixed in the step (III) is smaller than the above lower limit, cations in the interlayers other than the cations (α) may not sufficiently be substituted by lithium ions. If the amount of the lithium salt mixed in the step (III) is larger than the above upper limit, this may be economically inadvisable.

The second production method of allowing a lithium salt and a salt of the cations (α) to interact with a layered titanic acid includes the step (IV) of mixing a layered titanic acid, a lithium salt, and a salt of the cations (α).

When in the step (IV) a layered titanic acid is mixed with a lithium salt and a salt of the cations (α), the lithium salt and the salt of the cations (α) react by ion exchange with hydrogen ions, hydronium ions, and so on in the interlayers.

The step (IV) is preferably a wet treatment and is normally performed by adding a lithium salt and a salt of the cations (α) directly into a suspension containing a layered titanic acid dispersed into water or an aqueous medium or adding a dilution of the lithium salt and the salt of the cations (α) with water or an aqueous medium into the suspension, and stirring the mixture. The reaction temperature is preferably 25° C. to 85° C. and the reaction time is preferably 1 hour to 12 hours. When, after the reaction, the mixture is dried to remove the solvent, such as water, a titanate making up a solid electrolyte material according to the present invention can be produced.

The salt of the cations (α) for use in the step (IV) may be of any type that can introduce the cations (α) into the interlayers of the layered titanic acid and the preferred salts are calcium hydroxide and barium hydroxide octahydrate.

The lithium salt for use in the step (IV) may be of any type that can introduce lithium ions into the interlayers of the layered titanic acid, examples include lithium hydroxide monohydrate, lithium carbonate, lithium acetate, lithium citrate, lithium chloride, lithium nitrate, lithium sulfate, lithium phosphate, lithium bromide, lithium iodide, lithium tetraborate, LiPF₆, and LiBF₄, and the preferred lithium salt is lithium hydroxide monohydrate.

The amount of the lithium salt mixed in the step (IV) is, relative to the volume of exchangeable cations in the layered titanic acid, preferably 1.0 to 3.0 equivalents and more preferably 1.0 to 2.5 equivalents. If the amount of the lithium salt mixed in the step (IV) is smaller than the above lower limit, cations in the interlayers other than the cations (α) may not sufficiently be substituted by lithium ions. If the amount of the lithium salt mixed in the step (IV) is larger than the above upper limit, this may be economically inadvisable.

The amount of the salt of the cations (α) mixed in the step (IV) is, relative to the volume of exchangeable cations in the layered titanic acid, preferably 0.03 to 0.75 equivalents and more preferably 0.10 to 0.55 equivalents. If the amount of the salt of the cations (α) mixed in the step (IV) is smaller than the above lower limit, the amount of the cations (α) introduced into the interlayers becomes small, which may not provide a sufficient electrostatic interaction with the host layers and may deteriorate the electrochemical stability. If the amount of the salt of the cations (α) mixed in the step (IV) is larger than the above upper limit, this may be economically inadvisable.

### <Solid Electrolyte>

A solid electrolyte according to the present invention is a solid electrolyte comprising the above-described titanic acid-based solid electrolyte material and is a layer free of flammable organic solvent and capable of conducting lithium ions.

The proportion of the titanic acid-based solid electrolyte material contained in the solid electrolyte is, relative to a total amount of 100% by mass of the solid electrolyte, preferably 10% by mass to 100% by mass, more preferably 50% by mass to 100% by mass, and still more preferably 75% by mass to 100% by mass. The solid electrolyte may contain: a binder that binds particles of the titanic acid-based solid electrolyte material together; and solid electrolyte materials other than the titanic acid-based solid electrolyte material according to the present invention without impairing the excellent effects of the present invention.

An example of the other solid electrolyte materials is a polymer electrolyte obtained as a mixture of a polymer and a lithium salt. Examples of the polymer include: poly(meth)acrylic acids, such as polyacrylic acid (PAA) and polymethacrylic acid (PMAA); poly(meth)acrylates, such as poly-2-hydroxyethylacrylate and poly-2-hydroxyethylmethacrylate; poly(meth)acrylamides, such as polyacrylamide (PAAm) and polymethacrylamide (PMAm); polyethylene oxide (PEO); polycarbonate (PC); polyethylene terephthalate (PET); and copolymers of them. These polymers may be used singly or in combination of two or more of them. Examples of the lithium salt include LiPF₆, LiClO₄, LiBF₄, lithium bis(fluorosulfonyl)imide (LiFSI), and lithium bis(trifluoromethanesulfonyl)imide (LiTFSI). These lithium salts may be used singly or in combination of two or more of them.

The thickness of the solid electrolyte is preferably 0.1 μm to 1000 μm and more preferably 0.1 μm to 300 μm.

Examples of the method for forming a solid electrolyte include a method of sintering a titanic acid-based solid electrolyte material and a method of producing a solid electrolyte sheet containing a binder. The materials that can be used as the binder are the same materials as binders for use in the above-described polymer electrolyte or as described as binders for use in a positive electrode and a negative electrode, both to be described hereinafter. The temperature of the sintering is preferably set to be lower than the heat treatment temperature during production of the titanic acid-based solid electrolyte material in order to prevent the crystal structure of the titanic acid-based solid electrolyte material from changing during sintering.

Since the solid electrolyte according to the present invention has excellent electrochemical stability and lithium-ion conductivity and is free of sulfur, it can be suitably used as a solid electrolyte for a lithium-ion secondary battery.

In addition, the solid electrolyte according to the present invention is free from risk of production of hydrogen sulfide since it is free of sulfur, and it is excellent in production cost because of no use of rare earth.

### <Battery>

A battery according to the present invention is a lithium-ion secondary battery which includes a positive electrode, a negative electrode, and a solid electrolyte disposed between the positive electrode and the negative electrode and in which the solid electrolyte contains the titanic acid-based solid electrolyte material according to the present invention, i.e., an all-solid-state battery.

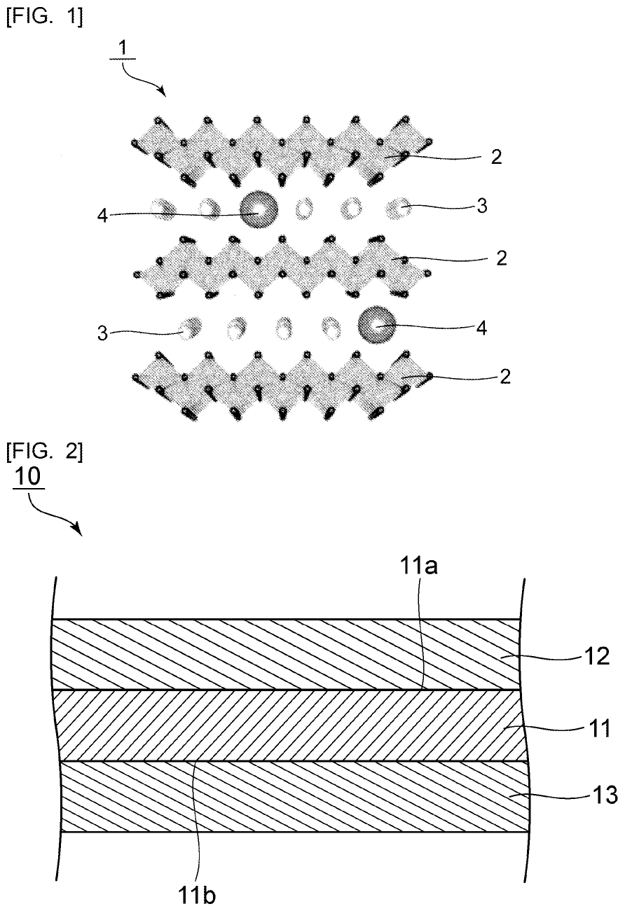

More specifically, FIG. 2 is a schematic cross-sectional view showing a lithium-ion secondary battery according to an embodiment of the present invention.

As shown in FIG. 2, the lithium-ion secondary battery 10 includes a solid electrolyte 11, a positive electrode 12, and a negative electrode 13. The solid electrolyte 11 has a first principal surface 11a and a second principal surface 11b opposed to each other. The solid electrolyte 11 is made of a solid electrolyte containing the above-described titanic acid-based solid electrolyte material according to the present invention. The positive electrode 12 is laid on the first principal surface 11a of the solid electrolyte 11. The negative electrode 13 is laid on the second principal surface 11b of the solid electrolyte 11.

The method for producing the battery according to the present invention is not particularly limited so long as it is a method that can provide the above-described battery, and the same method as any known battery production method can be used. An example is a production method of sequentially laying and pressing a positive electrode, a solid electrolyte, and a negative electrode one on top of another to make an electric-generating element, enclosing the electric-generating element in a battery case, and swaging the battery case.

Any general battery case can be used as the battery case for use in the battery according to the present invention. An example of the battery case is a battery case made of stainless steel.

Since the solid electrolyte according to the present invention is disposed in the battery according to the present invention, the battery is free from risk of production of hydrogen sulfide and therefore has excellent safety. Because of high lithium-ion conductivity of the solid electrolyte, a high-power battery can be achieved using the solid electrolyte. The battery has high electrochemical stability and therefore has excellent reliability. In addition, since the solid electrolyte is disposed in the battery, it also serves as a separation film and eliminates the need for an existing separation film and, therefore, thickness reduction of the battery can be expected.

Hereinafter, a description will be given of components of the battery according to the present invention.

### (Positive Electrode)

The positive electrode forming part of the battery according to the present invention includes a positive-electrode current collector and a positive-electrode active material layer.

Examples of the material for the positive-electrode current collector include copper, nickel, stainless steel, iron, titanium, aluminum, and aluminum alloy and the preferred material is aluminum. The thickness and shape of the positive-electrode current collector can be appropriately selected according to the usage and so on of the battery and, for example, the positive-electrode current collector may have the shape of a planar strip. In the case of a strip-shaped positive-electrode current collector, it can have a first surface and a second surface as the side of the positive-electrode current collector opposite to the first surface. The positive-electrode active material layer can be formed on one or both surfaces of the positive-electrode current collector.

The positive-electrode active material layer is a layer containing a positive-electrode active material and may contain, as necessary, a conductive material and a binder. The positive-electrode active material layer may further contain the titanic acid-based solid electrolyte material according to the present invention. When containing the titanic acid-based solid electrolyte material according to the present invention, the positive-electrode active material layer can have even higher electrochemical stability and even higher lithium-ion conductivity. The thickness of the positive-electrode active material layer is preferably 0.1 μm to 1000 μm.

The positive-electrode active material may be of any type that can absorb and release lithium or lithium ions, and examples include lithium cobaltate (LiCoO₂), lithium nickelate (LiNiO₂), lithium manganate (LiMnO₂), lithium nickel cobalt aluminate (such as LiNi_{0.8}Co_{0.15}Al_{0.05}O₂), lithium nickel cobalt manganate (such as LiNi_{1/3}Mn_{1/3}Co_{1/3}O₂ and Li₁₊ₓNi_{1/3}Mn_{1/3}Co_{1/3}O₂ (0≤x<0.3)), spinel oxides (LiM₂O₄ where M=Mn or V), lithium metal phosphates (LiMPO₄ where M=Fe, Mn, Co or Ni), silicate oxides (Li₂MSiO₄ where M=Mn, Fe, Co or Ni), LiNi_{0.5}Mn_{1.5}O₄, and S₈.

The conductive material is mixed in order to increase the current collecting performance and reduce the contact resistance between the positive-electrode active material and the positive-electrode current collector and examples include carbon-based materials, such as vapor-grown carbon fibers (VGCF), coke, carbon black, acetylene black, Ketjenblack, graphite, carbon nanofibers, and carbon nanotubes.

The binder is mixed in order to fill voids in the dispersed positive-electrode active material and also bind the positive-electrode active material and the positive-electrode current collector together and examples thereof include: synthetic rubbers, such as polysiloxane, polyalkylene glycol, ethyl-vinyl alcohol copolymer, carboxymethylcellulose (CMC), hydroxypropyl methylcellulose propyl (HPMC), cellulose acetate, polytetrafluoroethylene (PTFE), polyvinylidene fluoride (PVDF), polyvinylidene fluoride-hexafluoropropylene copolymer (PVDF-HFP), butadiene rubber, styrene-butadiene rubber (SBR), styrene-butadiene-styrene copolymer (SBS), styrene-ethylene-butadiene-styrene copolymer (SEBS), ethylene-propylene rubber, butyl rubber, chloroprene rubber, acrylonitrile-butadiene rubber, acrylic rubber, silicone rubber, fluororubber, and urethane rubber; polyimide; polyamide; polyamide imide; polyvinyl alcohol; and chlorinated polyethylene (CPE).

In an example of a method for producing a positive electrode, a positive-electrode active material, a conductive material, and a binder are suspended in a solvent to prepare a slurry and the slurry is applied to one surface or both surfaces of a positive-electrode current collector. Next, the applied slurry is dried to obtain a laminate of a positive-electrode active material-containing layer and the positive-electrode current collector. Thereafter, in the method, the laminate is pressed. In another method, a positive-electrode active material, a conductive material, and a binder are mixed and the resultant mixture is molded into pellets. Next, in the method, these pellets are disposed on a positive-electrode current collector.

### (Negative Electrode)

The negative electrode forming part of the battery according to the present invention includes a negative-electrode current collector and a negative-electrode active material layer.

Examples of the material for the negative-electrode current collector include stainless steel, copper, nickel, and carbon and the preferred material is copper. The thickness and shape of the negative-electrode current collector can be appropriately selected according to the usage and so on of the battery and, for example, the negative-electrode current collector may have the shape of a planar strip. In the case of a strip-shaped current collector, it can have a first surface and a second surface as the side of the current collector opposite to the first surface. The negative-electrode active material layer can be formed on one or both surfaces of the negative-electrode current collector.

The negative-electrode active material layer is a layer containing a negative-electrode active material and may contain a conductive material and a binder as necessary. The negative-electrode active material layer may further contain the titanic acid-based solid electrolyte material according to the present invention. When containing the titanic acid-based solid electrolyte material according to the present invention, the negative-electrode active material layer can have even higher lithium-ion conductivity. The thickness of the negative-electrode active material layer is preferably 0.1 μm to 1000 μm.

Examples of the material for the negative-electrode active material include metal active materials, carbon active materials, lithium metal, oxides, nitrides, and mixtures of them. The metal active materials include In, Al, Si, and Sn. The carbon active materials include mesocarbon microbeads (MCMB), highly oriented graphite (HOPG), hard carbon, and soft carbon. An example of the oxides is Li₄Ti₅O₁₂. An example of the nitrides is LiCoN.

The conductive material is mixed in order to increase the current collecting performance and reduce the contact resistance between the negative-electrode active material and the negative-electrode current collector and examples include carbon-based materials, such as vapor-grown carbon fibers (VGCF), coke, carbon black, acetylene black, Ketjenblack, graphite, carbon nanofibers, and carbon nanotubes.

The binder is mixed in order to fill voids in the dispersed negative-electrode active material and also bind the negative-electrode active material and the negative-electrode current collector together and examples thereof include: synthetic rubbers, such as polysiloxane, polyalkylene glycol, polyacrylic acid, carboxymethylcellulose (CMC), hydroxypropyl methylcellulose propyl (HPMC), cellulose acetate, polytetrafluoroethylene (PTFE), polyvinylidene fluoride (PVDF), polyvinylidene fluoride-hexafluoropropylene copolymer (PVDF-HFP), butadiene rubber, styrene-butadiene rubber (SBR), styrene-butadiene-styrene copolymer (SBS), styrene-ethylene-butadiene-styrene copolymer (SEBS), ethylene-propylene rubber, butyl rubber, chloroprene rubber, acrylonitrile-butadiene rubber, acrylic rubber, silicone rubber, fluororubber, and urethane rubber; polyimide; polyamide; polyamide imide; polyvinyl alcohol; and chlorinated polyethylene (CPE).

In an example of a method for producing a negative electrode, a negative-electrode active material, a conductive material, and a binder are suspended in a solvent to prepare a slurry and the slurry is applied to one surface or both surfaces of a negative-electrode current collector. Next, the applied slurry is dried to obtain a laminate of a negative-electrode active material-containing layer and the negative-electrode current collector. Thereafter, in the method, the laminate is pressed. In another method, a negative-electrode active material, a conductive material, and a binder are mixed and the resultant mixture is molded into pellets. Next, in the method, these pellets are disposed on a negative-electrode current collector.

### EXAMPLES

The present invention will be described below in further detail with reference to specific examples. The present invention is not at all limited by the following examples and modifications and variations may be appropriately made therein without changing the gist of the invention.

Source titanates used in Examples and Comparative Examples and the resultant powders were measured in terms of average particle diameter with a laser diffraction particle size distribution measurement device (SALD-2300 manufactured by Shimadzu Corporation) and confirmed in terms of interlayer distance by analysis with an X-ray diffraction measurement device (Ultima IV manufactured by Rigaku Corporation). Furthermore, the composition formulae were confirmed with an ICP-AES analyzer (Agilent 5110 Type VDV manufactured by Agilent Technologies, Inc.) and a thermogravimetric apparatus (NEXTA STA300, manufactured by Hitachi High-Tech Science Corporation).

### <Source Titanate and Organified Titanate>

The source titanates and organified titanates used in Examples and Comparative Examples are as follows.

### (Source Titanate)

A lepidocrocite potassium lithium titanate (K_{0.6}Li_{0.27}Ti_{1.73}O_{3.9}) containing potassium ions in the interlayers and lithium ions in the host layers was used as a source titanate. The lepidocrocite potassium lithium titanate had an average particle diameter of 3 μm, was white powder made of platy particles, and had an interlayer distance of 7.8 Angstroms.

### (Organified Titanate)

An amount of 30 g of source titanate was dispersed into 438 mL of deionized water and 23.3 g of 95% sulfuric acid was added to the liquid. The mixed liquid was stirred at 25° C. for an hour and then subjected to separation and the separated product was washed with water. This process was repeated twice, thus obtaining a lepidocrocite titanic acid in which some of potassium ions and some of lithium ions in the source titanate were exchanged for hydrogen ions or hydronium ions. The lepidocrocite titanic acid was dispersed into 3.2 L of deionized water, 23.5 g of n-butylamine was added into the liquid, and the mixed liquid was stirred for two hours with heating at 80° C. and then filtered, thus extracting an organified lepidocrocite titanate (an organified titanate).

### Example 1

An amount of 3.0 g of aluminum nitrate enneahydrate was dissolved into 38.7 mL of deionized water, 73.8 g of 0.2 mol/L n-butylamine aqueous solution was added dropwise to the aluminum nitrate aqueous solution, and the mixture was then allowed to stand at 60° C., thus synthesizing polynuclear metal cations of aluminum ([Al₁₃O₄(OH)₂₄(H₂O)₁₂]⁷⁺). An amount of 5.0 g of organified titanate was added to the synthesized material and the mixture was stirred at 80° C. for 15 hours, followed by filtration and thorough washing to obtain a powder. The obtained powder was dispersed into 49.3 g of 1.0 mol/L lithium chloride aqueous solution and the liquid was stirred with heating at 80° C. for three hours, followed by filtration and thorough washing to obtain a powdered lepidocrocite titanate.

The average particle diameter and the interlayer distance of the obtained lepidocrocite titanate were 4 μm and 16 Angstroms, respectively.

### Example 2

An amount of 20 g of source titanate was dispersed into 292 mL of deionized water and 15.5 g of 95% sulfuric acid was added to the liquid. The mixed liquid was stirred at 25° C. for an hour and then subjected to separation and the separated product was washed with water. This process was repeated twice, thus obtaining a lepidocrocite titanic acid in which some of potassium ions and some of lithium ions in the source titanate were exchanged for hydrogen ions or hydronium ions. The lepidocrocite titanic acid was dispersed into 100 mL of deionized water, an aqueous solution containing 4.4 g of barium hydroxide octahydrate and 4.7 g of lithium hydroxide monohydrate dissolved in 560 mL of deionized water was added into the dispersion liquid, and the mixed liquid was stirred for three hours with heating at 40° C., followed by filtration, thorough washing, and drying in air at 110° C. for 12 hours to obtain a powdered lepidocrocite titanate.

The average particle diameter, interlayer distance, and composition formula of the obtained lepidocrocite titanate were 3 μm, 8.9 Angstroms, and Li_{0.39}K_{0.09}Ba_{0.20}Ti_{1.73}O_{3.9}—1.0H₂O, respectively.

### Example 3

An amount of 0.94 g of magnesium chloride hexahydrate was dissolved into 46.2 g of deionized water, 5.0 g of organified titanate was added into the liquid, and the mixture liquid was stirred with heating for two hours, followed by filtration and thorough washing to obtain a powder. The obtained powder was dispersed into 49.3 g of 1.0 mol/L lithium chloride aqueous solution and the liquid was stirred with heating at 80° C. for three hours, followed by filtration and thorough washing to obtain a powdered lepidocrocite titanate.

The average particle diameter, interlayer distance, and composition formula of the obtained lepidocrocite titanate were 3 μm, 10 Angstroms, and Li_{0.13}K_{0.04}Mg_{0.16}Ti_{1.73}O_{3.7}·1.7H₂O, respectively.

### Example 4

An amount of 0.70 g of aluminum chloride hexahydrate was dissolved into 28.8 mL of deionized water, 5.0 g of organified titanate was added into the liquid, and the mixture liquid was stirred with heating for two hours, followed by filtration and thorough washing to obtain a powder. The obtained powder was dispersed into 49.3 g of 1.0 mol/L lithium chloride aqueous solution and the liquid was stirred with heating at 80° C. for three hours, followed by filtration and thorough washing to obtain a powdered lepidocrocite titanate.

The average particle diameter, interlayer distance, and composition formula of the obtained lepidocrocite titanate were 3·μm, 9.2 Angstroms, and Li_{0.14}K_{0.05}Al_{0.12}Ti_{1.73}O_{3.7}·1.0H₂O, respectively.

### Comparative Example 1

An amount of 65 g of source titanate was dispersed into 1 L of deionized water and 50.4 g of 95% sulfuric acid was added to the liquid. The mixed liquid was stirred at 25° C. for an hour and then subjected to separation and the separated product was washed with water. This process was repeated twice, thus obtaining a lepidocrocite titanic acid in which some of potassium ions and some of lithium ions in the source titanate were exchanged for hydrogen ions or hydronium ions. An amount of 50 g of the lepidocrocite titanic acid was dispersed into 200 mL of deionized water and 324 mL of 10% aqueous solution of lithium hydroxide monohydrate was added to the liquid with heating to 70° C. and stirring. The liquid was stirred at 70° C. for three hours and then a residue was filtered out. The residue was well washed with hot water at 70° C. and then dried in air at 110° C. for 12 hours, thus obtaining a powdered lepidocrocite titanate.

The average particle diameter, interlayer distance, and composition formula of the obtained lepidocrocite titanate were 3 μm, 8.4 Angstroms, and K_{0.07}Li_{1.0}Ti_{1.73}O₄·0.97H₂O, respectively.

### Comparative Example 2

A product Li_{0.33}La_{0.55}TiO₃ (cubic) (LLTO) manufactured by Toshima Manufacturing Co., Ltd. was used as a comparative example. The average particle diameter was 5 μm.

### <Measurement of Impedance>

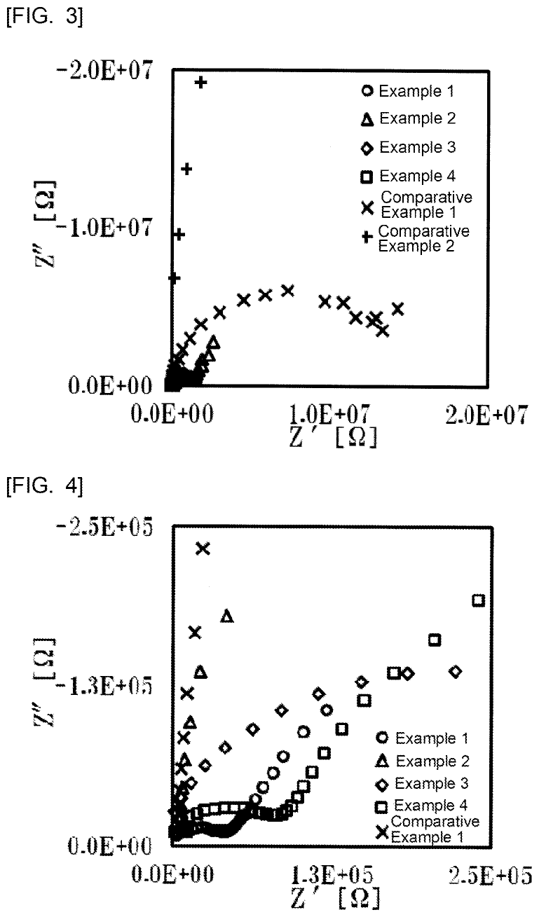

An amount of 0.050 g of each of samples of the lepidocrocite titanates obtained in Examples 1 to 4 and Comparative Example 1 and the LLTO in Comparative Example 2 was put into a container made of Teflon (registered trademark) and having 0.8 cm diameter copper electrodes at both ends and measured in terms of impedance in a range of 1 MHz to 70 Hz by the AC impedance method while pressure was applied to the sample to give the sample a thickness of 1.0 mm (measurement device: CompactStat manufactured by Ivium Technologies). FIGS. 3 and 4 show Nyquist diagrams. FIG. 4 shows in magnification portions of Examples 1 to 4 and Comparative Example 1 in FIG. 3. The Nyquist diagrams show semicircular features at higher frequencies and spike features at shorter frequencies and it can be considered that the smaller the semicircle at higher frequencies, the more excellent the ionic conductivity. It can be seen from FIGS. 3 and 4 that Examples 1 to 4 have ionic conductivity as good as or better than Comparative Examples 1 to 2.

<Analysis of dQ/dV Curves>

The samples of the lepidocrocite titanates obtained in Examples 1 to 4 and Comparative Example 1 were analyzed in terms of their dQ/dV curves. Specifically, a slurry in which the evaluation sample, a conductive material, PVdF, and NMP were mixed was coated on copper foil, the coated copper foil was dried and then punched into a piece, the piece of coated copper foil was used together with lithium metal as a counter electrode, 1.0 M LiPF₆ (EC/DMC=50/50 (v/v)) as an electrolytic solution, and porous PP as a separator to produce a coin cell battery, and the coin cell battery was subjected to charge-discharge measurements. From the obtained charge and discharge results, dQ/dV curves were created.

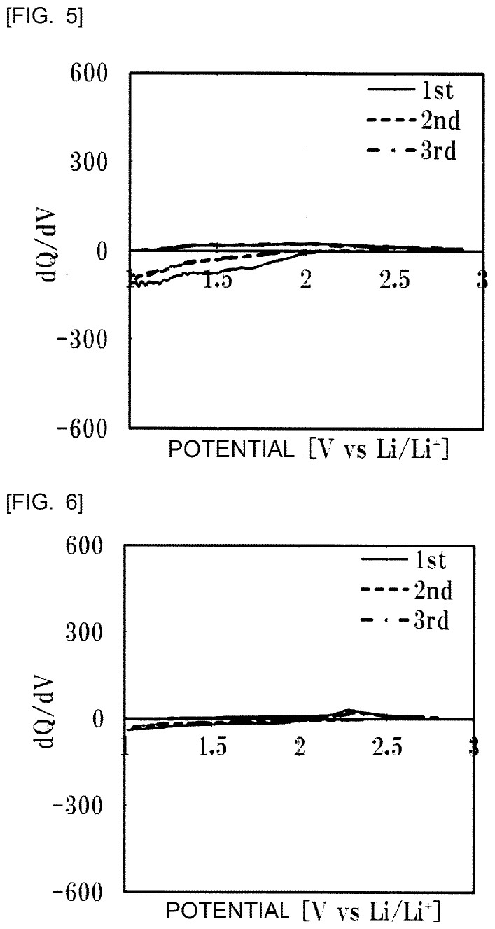

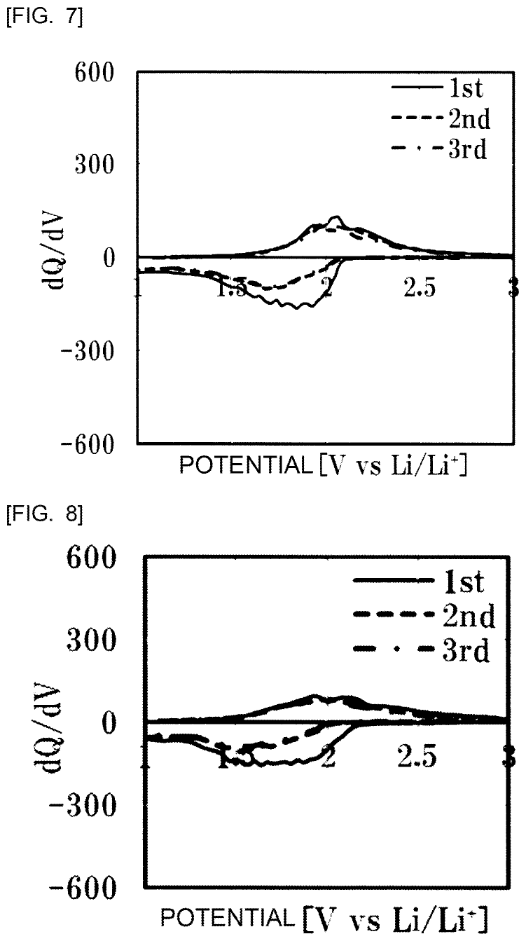

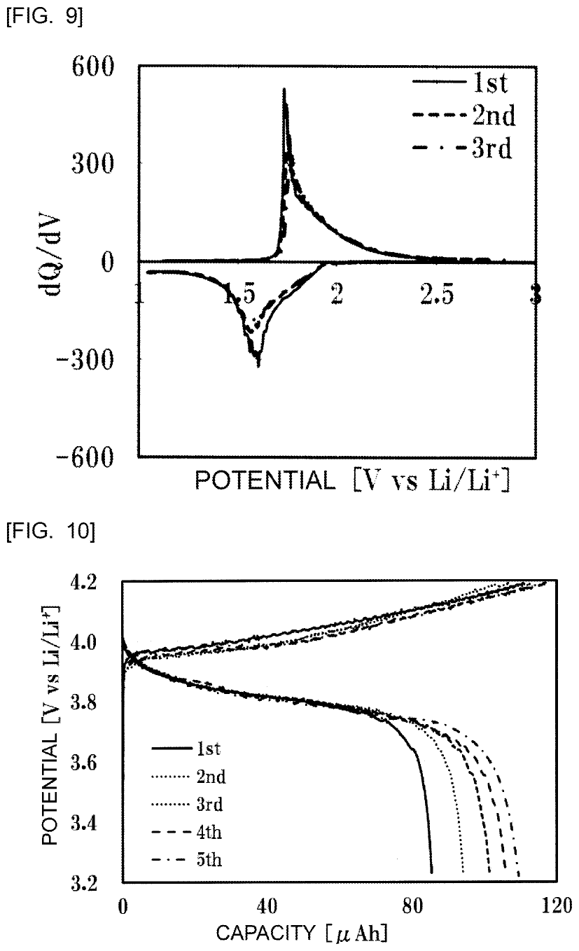

The results are shown in FIGS. 5 to 9. FIG. 5 is the results from the sample of Example 1, FIG. 6 is the results from the sample of Example 2, FIG. 7 is the results from the sample of Example 3, and FIG. 8 is the results from the sample of Example 4. FIG. 9 is the results from the sample of Comparative Example 1.

As seen from FIGS. 5 to 9, large peaks like those observed in the dQ/dV curves from the sample of Comparative Example 1 were not observed in the dQ/dV curves from the samples of Examples 1 to 4 and, therefore, the samples of Examples 1 to 4 were confirmed to have excellent electrochemical stability. Particularly, as for the samples of Examples 1 to 2, substantially no peak was observed in their dQ/dV curves and, therefore, these samples were confirmed to have more excellent electrochemical stability.

### <Measurement of All-Solid-State Battery>

The sample of the lepidocrocite titanate obtained in Example 1 was evaluated in terms of all-solid-state battery. Specifically, the sample of Example 1, lithium cobaltate, and a conductive material were mixed at a ratio of 8.5:8.5:1. A 10 wt % NMP solution of PVdF was added to the mixture, NMP was further added to the mixture liquid to prepare a slurry, the slurry was coated on aluminum foil, dried at 60° C. for 15 hours, thus producing a positive electrode layer. A slurry was prepared and adjusted in viscosity by mixing a 20 wt % aqueous solution of binder containing polyethylene oxide (with a molecular weight of 20000) and lithium bis(trifluoromethanesulfonyl)imide dissolved in ultrapure water to give a molar ratio of 20:1 between ethylene oxide sites and lithium ions, together with the sample of Example 1 at a mass ratio of 5:3. The slurry was coated on the dried positive electrode layer, the coated positive electrode layer was dried at 60° C. for 15 hours and then punched into a piece, and a coin cell battery was produced using the piece together with lithium metal as a counter electrode and a film as a buffer layer prepared from a solution of polyethylene oxide (with a molecular weight of 400000) and lithium bis(trifluoromethanesulfonyl)imide dissolved in acetonitrile to give a molar ratio of 18:1 between ethylene oxide sites and lithium ions, and the coin cell battery was subjected to charge-discharge measurements at 0.01 C and room temperature.

The results are shown in FIG. 10. It was confirmed from FIG. 10 that the all-solid-state battery in which Example 1 was used as a solid electrolyte operated as a battery.

### REFERENCE SIGNS LIST

1 . . . titanic acid-based solid electrolyte material
2 . . . host layer
3 . . . lithium ion
4 . . . cation (a)
10 . . . lithium-ion secondary battery
11 . . . solid electrolyte
11a . . . first principal surface
11b . . . second principal surface
12 . . . positive electrode
13 . . . negative electrode

1. A titanic acid-based solid electrolyte material made of a titanate having a structure in which a plurality of host layers are laid one on top of another, the host layer being formed so that octahedra each formed of a titanium atom coordinated with six oxygen atoms are two-dimensionally chained while sharing ridges, and lithium ions and divalent or higher-valent cations (α) are intercalated in interlayers between the host layers, titanium sites in the host layers being partially substituted by monovalent to trivalent cations (β).

2. The titanic acid-based solid electrolyte material according to claim 1, wherein the cations (α) are divalent to octavalent cations.

3. The titanic acid-based solid electrolyte material according to claim 1, wherein the cations (α) comprise at least one type of ion selected from the group consisting of a magnesium ion, an aluminum ion, a calcium ion, a zinc ion, a strontium ion, a barium ion, [Al₁₃O₄(OH)₂₄(H₂O)₁₂]⁷⁺, [Ga₁₃O₄(OH)₂₄(H₂O)₁₂]⁷⁺, and [Zr₄(OH)₈(H₂O)₁₆]⁸⁺.

4. The titanic acid-based solid electrolyte material according to claim 1, wherein the cations (α) have an ionic radius of 0.50 Angstroms or more.

5. The titanic acid-based solid electrolyte material according to claim 1, wherein a content of the lithium ions present in the interlayers between the host layers is 35% by mole to 95% by mole relative to 100% by mole of ions present in the interlayers between the host layers.

6. The titanic acid-based solid electrolyte material according to claim 1, wherein a content ratio between the cations (α) and the lithium ions present in the interlayers between the host layers ((cations (α))/(lithium ions)) is 1/99 to 60/40 in terms of molar ratio.

7. The titanic acid-based solid electrolyte material according to claim 1, wherein the cations (β) comprise at least one type of ion selected from the group consisting of a hydrogen ion, an oxonium ion, a lithium ion, and a magnesium ion.

8. The titanic acid-based solid electrolyte material according to claim 1, wherein more than 0% by mole and not more than 40% by mole of the titanium sites in the host layers are substituted by the cations (β).

9. The titanic acid-based solid electrolyte material according to claim 1, wherein an interlayer distance between the host layers is 5 Angstroms to 20 Angstroms.

10. A method for producing the titanic acid-based solid electrolyte material according to claim 1, the method comprising the steps of: (I) allowing a titanic acid having a layered crystal structure to interact with a basic compound or a salt of the basic compound; (II) mixing a compound obtained in the step (I) and a salt of the cations (α); and (III) mixing a compound obtained in the step (II) and a lithium salt.

11. A method for producing the titanic acid-based solid electrolyte material according to claim 1, the method comprising the step (IV) of mixing a titanic acid having a layered crystal structure, a lithium salt, and a salt of the cations (α).

12. A solid electrolyte containing the titanic acid-based solid electrolyte material according to claim 1.

13. A lithium-ion secondary battery comprising the solid electrolyte according to claim 12.
